(19) United States
(12) Patent Application Publication
(10) Pub. No.: US 2026/0150041 A1
(43) Pub. Date: May 28, 2026

(54) METHOD, APPARATUS AND SYSTEM FOR POWER SAVING IN NETWORK COMMUNICATIONS

(71) Applicant: Huawei Technologies Co., Ltd., Shenzhen (CN)

(72) Inventors: Liqing Zhang, Ottawa (CA); Wen Tong, Ottawa (CA); Jianglei Ma, Ottawa (CA); Hao Tang, Ottawa (CA)

(21) Appl. No.: 19/453,754

(22) Filed: Jan. 20, 2026

Related U.S. Application Data
(63) Continuation of application No. PCT/CN2023/130330, filed on Nov. 8, 2023.
(60) Provisional application No. 63/514,884, filed on Jul. 21, 2023.

(51) Int. Cl. H04W 52/02

(52) U.S. Cl. CPC H04W 52/0209

(57) ABSTRACT

Aspects of the present application relate to defining a plurality of energy consumption levels for various operational states. Each energy consumption level may be associated with a configuration. The configuration may include values for a plurality of parameters. The parameters may be used for communication. As these parameters may affect the energy consumption of a transmission.

### CROSS-REFERENCE TO RELATED APPLICATIONS

This application is a continuation of International Patent Application No. PCT/CN2023/130330, filed Nov. 8, 2023, which claims the benefit of U.S. Provisional Patent Application No. 63/514,884, filed Jul. 21, 2023, all of which are incorporated by reference herein in their entirety.

### TECHNICAL FIELD

The present disclosure relates, generally, to wireless communication networks and, in particular embodiments, to a manner of saving power at elements of such networks.

### BACKGROUND

The Radio Resource Control (RRC) protocol is a network communications protocol used in communications between a device, such as a user equipment (UE), and a network entity, such as a base station. This protocol is specified in, for example, 3GPP in TS 25.331 for UMTS, in TS 36.331 for LTE and in TS 38.331 for 5G New Radio, which are incorporated by reference herein in their entirety.

Energy saving in current wireless communication networks may be accomplished by way of, for example, an RRC state transition. According to the current RRC protocol, a UE may be in one of three operational states, namely an RRC connected state, an RRC inactive state and an RRC idle state. The current operational state of a device is associated with a device's level of activity. For example, different limitations on the UE's transmission or reception behaviors/activities, monitoring/sending network messages, and/or measurement and reporting occasions may be associated with different operational states. As a result, each of these operational states are known to be associated with different degrees of energy consumption. When a device changes from one RRC state to another RRC state, the change may be called a state transition. The implementation of state transitions in a network, and the associated change in level of resource usage, may be shown to reduce overall time-frequency resource usage in a network.

However, the RRC operational state scheme does not allow for control over the way in which a network communication is performed. In particular, it does not allow parameters associated with a communication to be set in order to improve energy consumption for a communication.

### SUMMARY

Aspects of the present application relate to defining a plurality of energy consumption levels for various operational states, which may, alternatively, be referred to as operational modes. Energy consumption levels may also be referred to as power levels herein. Each energy consumption level may be associated with a configuration. The configuration may include values for a plurality of parameters. The parameters may be used for communication. The parameters may include one or more of transceiver parameters including transceiver type, antennal parameters, beam information, directional weights for steering a beam direction, modulation and coding scheme parameters, waveform parameters, frame structure parameters, numerology parameters and maximum transmission power parameters. As these parameters may affect the energy consumption of a transmission, finer and more accurate control may be executed over the energy consumption of a network communication.

In known networks, there may be a coarse power level control using operational states of an RRC protocol as mentioned above. The present application proposes a plurality of energy consumption levels for each operational state. Moreover, the present application also addresses mechanisms or triggering criteria for switching between energy consumption levels and/or between different operational states in relation to energy consumption and power control.

Conveniently, aspects of the present application allow for more accurate energy consumption and control. More accurate energy consumption and control may be shown to allow for lower overall energy consumption.

According to an aspect of the present disclosure, there is provided a method. The method includes receiving an indication of a first energy consumption level, wherein the first energy consumption level is one of a plurality of energy consumption levels, each energy consumption level in the plurality of energy consumption levels being associated with a configuration, each configuration including values for a plurality of parameters. The method further includes performing a communication between a device and a network entity based on the values for the parameters included in the configuration associated with the first energy consumption level. Information regarding a configuration associated with an energy consumption level may, for example, be transmitted through a higher layer signaling, such as RRC signaling, and may comprise information for a plurality of energy consumption levels (with energy consumption level indices), wherein each configuration may configure one or more energy consumption levels with a plurality of parameters. An indication of one energy consumption level, as a default or active energy consumption level on which the device may operate when performing the communication, can be indicated by a higher-layer signaling such as RRC or can be instructed (e.g., using an energy consumption level index) by dynamic signaling such as downlink control information (DCI).

According to aspects of the present application, each energy consumption level, in the plurality of energy consumption levels, is associated with an operational state, wherein the operational state is one of a connected state, an inactive state and an idle state.

According to aspects of the present application, the method includes, before the receiving, receiving initial configuration information, the initial configuration information providing the plurality of energy consumption levels and the associated configurations.

According to aspects of the present application, the plurality of parameters include at least one of a transmission parameter, a reception parameter, an antenna parameter, a transceiver type, beam information or directional weights in an antenna for steering a beam direction, a modulation coding scheme parameter, a waveform parameter, a frame structure parameter, a numerology parameter and a maximum transmission power parameter.

According to aspects of the present application, the method further includes receiving an instruction to switch from the first energy consumption level to a second energy consumption level, among the plurality of energy consumption levels.

According to aspects of the present application, the instruction may be based on information regarding channel quality.

According to aspects of the present application, the information regarding channel quality may be based on measurements made by the network entity.

According to aspects of the present application, the information regarding channel quality may be based on measurements made by the device.

According to aspects of the present application, the method includes receiving an instruction to switch from a current operational state to a new operational state.

According to aspects of the present application, the method includes transmitting an indication of a proposed energy consumption level, among the plurality of energy consumption levels.

According to aspects of the present application, the method includes receiving an acknowledgement of a switch to the proposed energy consumption level.

According to aspects of the present application, there is provided a device. The device includes a memory storing computer-readable instructions and a processor. The processor may be caused, by executing the instructions, to perform any of these methods. There is also provided a non-transitory computer-readable medium storing instruction, the instructions causing a processor in a device to implement any of these methods.

According to an aspect of the present disclosure, there is provided an apparatus. The apparatus includes a receiving unit configured to receive an indication of an energy consumption level, wherein the energy consumption level is among a plurality of energy consumption levels, each energy consumption level in the plurality of energy consumption levels being associated with a configuration, each configuration including values for a plurality of parameters. The apparatus further includes a communication unit configured to perform a communication between a device and a network entity, based on the values for the parameters included in the configuration associated with the energy consumption level.

According to an aspect of the present disclosure, there is provided a method. The method includes transmitting an indication of a first energy consumption level, wherein the first energy consumption level is one of a plurality of energy consumption levels, each energy consumption level, in the plurality of energy consumption levels, being associated with a configuration, each configuration including values for a plurality of parameters. The method further includes performing a communication between a network entity and a device based on the values for the parameters included in the configuration associated with the first energy consumption level.

According to aspects of the present application, each energy consumption level, in the plurality of energy consumption levels, is associated with an operational state, wherein the operational state is one of a connected state, an inactive state and an idle state.

According to aspects of the present application, the method includes, before the transmitting, transmitting initial configuration information, the initial configuration information providing the plurality of energy consumption levels and the associated configurations.

According to aspects of the present application, the plurality of parameters includes at least one of a transmission parameter, a reception parameter, an antenna parameter, a transceiver type, beam information or directional weights in an antenna for steering a beam direction, a modulation coding scheme parameter, a waveform parameter, a frame structure parameter, a numerology parameter and a maximum transmission power parameter.

According to aspects of the present application, the method further includes transmitting an instruction to switch from the first energy consumption level to a second energy consumption level, among the plurality of energy consumption levels.

According to aspects of the present application, the instruction is based on information regarding channel quality.

According to aspects of the present application, the information regarding channel quality is based on measurements made by the network entity.

According to aspects of the present application, the information regarding channel quality is based on a measurement report received the device.

According to aspects of the present application, the method further includes transmitting an instruction to switch from a current operational state to a new operational state.

According to aspects of the present application, the method further includes receiving an indication of a proposed energy consumption level, among the plurality of energy consumption levels.

According to aspects of the present application, the method further includes transmitting an acknowledgement of a switch to the proposed energy consumption level.

In other aspects, a network entity (25) is provided comprising a memory storing computer readable instructions and a processer caused, by executing the instructions, to implement these methods. There is further provided a non-transitory computer-readable medium storing instruction the instructions causing a processor in a device to implement these methods.

According to an aspect of the present disclosure, there is provided an apparatus. The apparatus includes a transmitting unit configured to transmit an indication of a first energy consumption level, wherein the energy consumption level is one of a plurality of energy consumption levels, each energy consumption level in the plurality of energy consumption levels being associated with a configuration, each configuration including values for a plurality of parameters. The apparatus further includes a communication unit configured to perform a communication between a device and a network entity, based on the values for the parameters included in the configuration associated with the energy consumption level.

According to aspects of the present application, there is provided a device configured to perform any of these methods.

According to aspects of the present application, there is provided a processor configured to execute instructions to cause a device to perform any of these methods.

According to aspects of the present application, there is provided an integrated circuit configured to perform any of these methods.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit receive points along with various networks;

FIG. 2 illustrates, in a block diagram, the communication system of FIG. 1, the communication system includes multiple example electronic devices, an example terrestrial transmit receive point and an example non-terrestrial transmit receive point along with various networks;

FIG. 3 illustrates, as a block diagram, elements of an example electronic device of FIG. 2, elements of an example terrestrial transmit receive point of FIG. 2 and elements of an example non-terrestrial transmit receive point of FIG. 2, in accordance with aspects of the present application;

FIG. 4 illustrates, as a block diagram, various modules that may be included in an example electronic device, an example terrestrial transmit receive point and an example non-terrestrial transmit receive point, in accordance with aspects of the present application;

FIG. 5 illustrates, as a block diagram, a sensing management function, in accordance with aspects of the present application;

FIG. 6 illustrates known operational states in general groups;

FIG. 7 illustrates an example bundle of energy consumption level configuration information, in accordance with aspects of the present application;

FIG. 8A illustrates, in another example bundle of energy consumption level configuration information, a first plurality of energy consumption levels for active states and a second plurality of energy consumption levels for inactive states, in accordance with aspects of the present application;

FIG. 8B schematically illustrates connections between the first plurality of energy consumption levels for active states of FIG. 8A and the second plurality of energy consumption levels for inactive states of FIG. 8A, in accordance with aspects of the present application;

FIG. 9 illustrates a plot of energy consumption level against time for a device operating in an active state in accordance with aspects of the present application;

FIG. 10 illustrates a plot of energy consumption level against time for a device operating in an inactive state in accordance with aspects of the present application;

FIG. 11 illustrates, in a signal flow diagram, a BS-side, downlink-based training scenario, in accordance with aspects of the present application;

FIG. 12 illustrates, in a signal flow diagram, a UE-side, downlink-based training scenario, in accordance with aspects of the present application;

FIG. 13 illustrates, in a signal flow diagram, a network-side, uplink-based training scenario, in accordance with aspects of the present application; and

FIG. 14 illustrates a scheme to learn operation power levels to impact wireless performance, in accordance with aspects of the present application.

### DETAILED DESCRIPTION

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

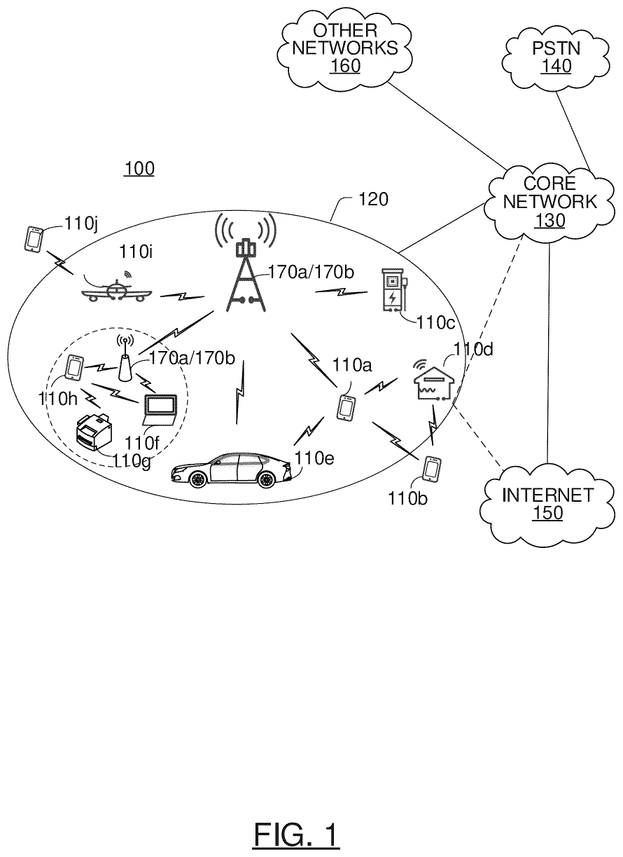

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electronic device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

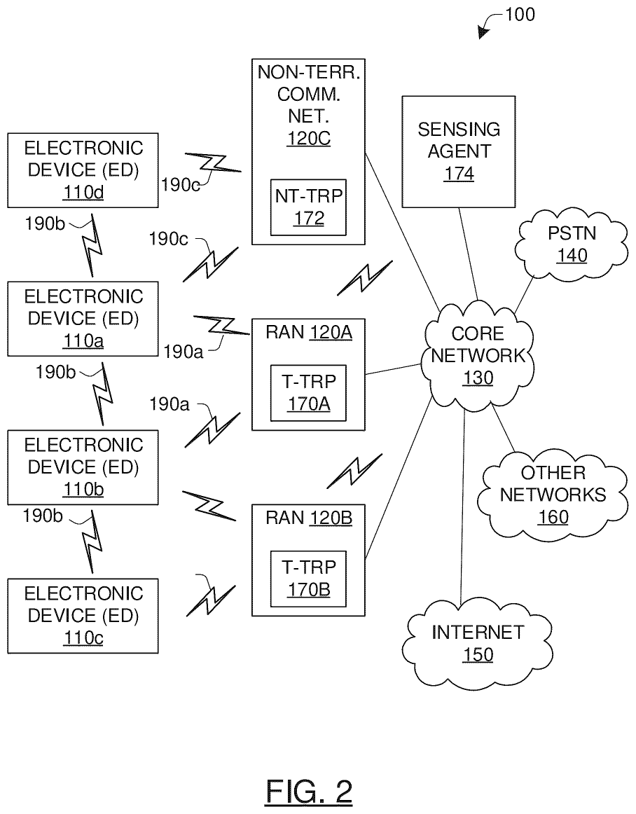

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), single-carrier FDMA (SC-FDMA) or Direct Fourier Transform spread OFDMA (DFT-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 1900 can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

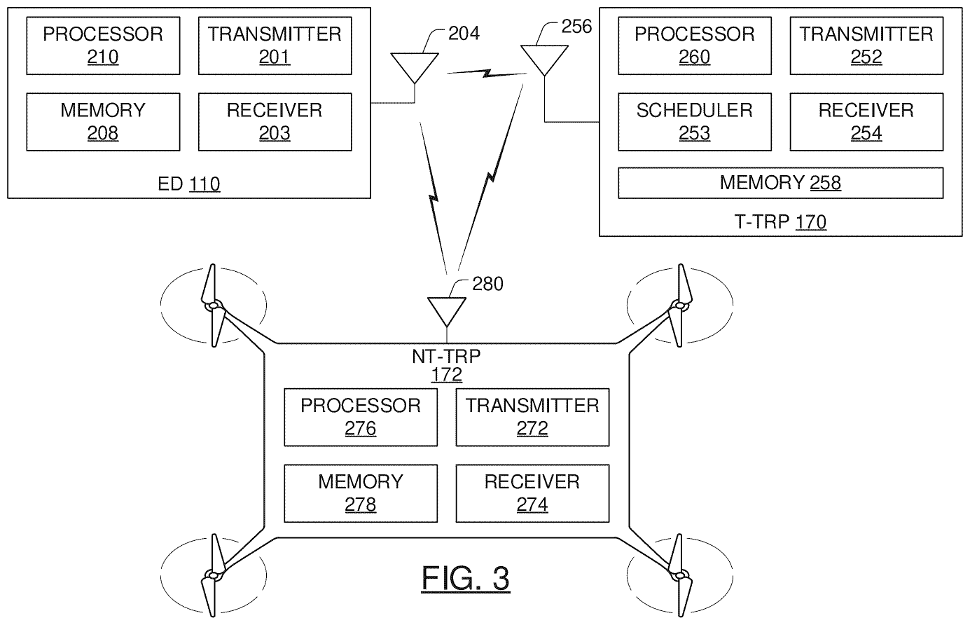

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IOT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, wearable devices such as a watch, head mounted equipment, a pair of glasses, a smart book, a vehicle, a car, a truck, a bus, a train, or an IoT device, an industrial device, or apparatus (e.g., communication module, modem, or chip) in the foregoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a Central Processing Unit (CPU), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the foregoing devices or refer to apparatus (e.g., a communication module, a modem or a chip) in the foregoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a CPU, a GPU or an ASIC.

Notably, the NT-TRP 172 is illustrated as a drone only as an example, the NT-TRP 172 may be implemented in any suitable non-terrestrial form, such as high altitude platforms, satellite, high altitude platform as international mobile telecommunication base stations and unmanned aerial vehicles, which forms will be discussed hereinafter. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a CPU, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

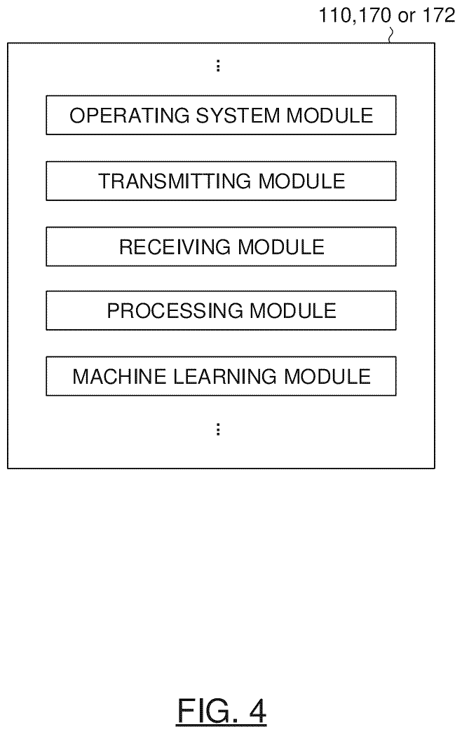

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a CPU, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Direct Fourier Transform spread OFDM (DFT-OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; OFDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control information (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

UE position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system is typically separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

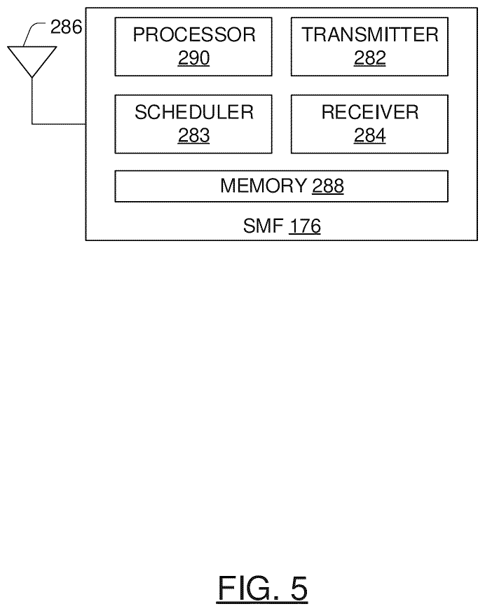

As shown in FIG. 5, an SMF 176, when implemented as a physically independent entity, includes at least one processor 290, at least one transmitter 282, at least one receiver 284, one or more antennas 286 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower energy consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node to have full-duplex capability. A half-duplex node may perform monostatic sensing with certain limitations, such as in a pulsed radar with a specific duty cycle and ranging capability.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπat}^{²} in the baseband representation.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectral efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectral efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or a Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

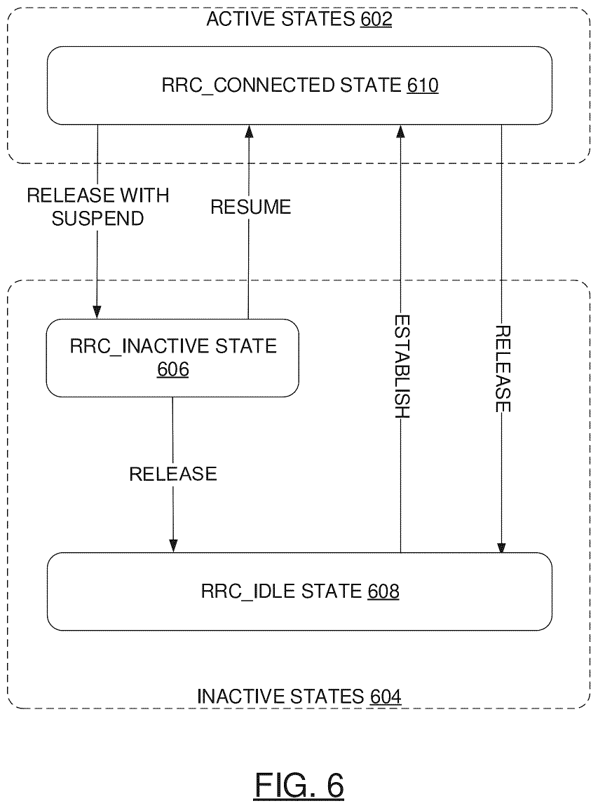

Operational states for a UE may be generally grouped, as illustrated in FIG. 6, in a group of active states 602 and a group of inactive states 604. A legacy network, such as network operating according to standards defined for fifth generation (“5G”) NR (New Radio), has three RRC states for a UE. These states are illustrated, in FIG. 6, as: an RRC connected state 610; an RRC inactive state 606; and an RRC idle state 608.

In the legacy network, a first UE in a first RRC state may perform transmission and/or reception activities that are different from transmission and/or reception activities that are performed by a second UE in a second RRC state. For example, in view of FIG. 6, it may be understood that a UE in the RRC connected state 610 can operate with full transmission activities and/or reception activities, including transmission behaviors, reception behaviors, monitoring network messages, sending network messages, measurement occasions and measurement reporting occasions.

In contrast, it may be understood that a UE in the RRC idle state 608 does not transmit any traffic. However, it may be expected that the UE in the RRC idle state 608 may monitor limited system messages and/or network messages.

It may be understood that a UE in the RRC inactive state 606 may maintain some network configuration information. The maintenance, in the RRC inactive state 606, of some network configuration information may be shown to allow for a state transition, called “resume,” from the RRC inactive state 606 to the RRC connected state 610 to occur more quickly and efficiently than a state transition, called “establish,” from the RRC idle state 608 to the RRC connected state 610. The maintenance of some network configuration information, while the UE is in the RRC inactive state 606, may be shown to allow for a transmission or reception of (possibly short) control or data messages between the UE and a base station. The transmission or reception of such control messages or data messages may be understood to be carried out in addition to the known set of operation behaviors of the UE while the UE is in the RRC idle state 608.

From the network perspective, a base station may have to deal with more than one UE. It follows that the base station may have to support operations at each UE among a plurality of UEs, with different UEs being in different RRC states. It has been contemplated that the base station may reduce energy consumption by sending a reduced number of system messages, such as system synchronization blocks (SSBs), paging messages, etc.

It has also been contemplated that the base station may reduce energy consumption by entering into a sleep mode, in which mode, e.g., the base station does not carry out any transmission operations or reception operations and, accordingly, the base station does not support any UEs.

It should be clear that such a network power saving is achieved at a cost of overall network performance, as the reduced number of system messages, such as SSBs or paging messages, may, during a network device/base station sleep mode duration, lead to a delay in support of UE operations or lead to a situation wherein a UE is not able to be supported.

It may be shown that elements of known networks are not configured to consider an association of energy consumption in a given RRC state with specific parameters (e.g., transmitter and receiver parameters).

Aspects of the present application relate to on-demand use of energy consumption levels in an operational state. A given operational state may be associated with a plurality of energy consumption levels. An energy consumption level may be associated with a configuration, which includes values for a plurality of parameters. The parameters may, for example, include transmission and/or reception parameters for communications between entities in a network, such as between a user device and a network entity. The values of the parameters included in a configuration associated with an energy consumption level may be used to perform a communication between a device and a network entity. In other words, the transmitting device in a communication between a user device (e.g., ED/UE 110) and a network entity (e.g., base station 170) may set parameters for the transmission to the values of the transmission parameters in the configuration associated with a current energy consumption index when performing the transmission. The receiving device in the communication may set parameters for reception of the transmission to values of reception parameters in the configuration associated with a current energy consumption index.

Transmission or reception (receiver) parameters of a configuration associated with an energy consumption level may comprise one or more of the following: transceiver type; antenna parameters; beam information; directional weights for steering a beam direction; modulation and coding scheme parameters; waveform parameters; frame structure parameters; numerology parameters; and maximum transmission power parameters. Directional weights, in particular, are known to be used in a beamforming process. The beamforming process involves feeding each antenna in an antenna array with the same to-be-transmitted signal. However, through adjustments to the phase and the amplitude of the to-be-transmitted signal fed to each element, a beam, carrying the to-be-transmitted signal, departs the antenna array in a desired direction.

Aspects of the present application relate to using the energy consumption levels to achieve on-demand power saving. As mentioned above, an energy consumption level is associated with a configuration which includes values for a plurality of parameters. As the parameters used in, for example, the transmission and/or reception of a communication between entities in a network, may directly affect the energy consumed for the communication, setting an energy consumption level for a communication may allow for control over energy consumption. Indeed, the granularity of the energy consumption levels may be seen to contrast with course energy consumption demonstrated by devices limited to the energy consumption in known operational states. A two-layer approach is proposed herein, with a layer that is associated with an operational state and a layer that associated with configuration parameters.

A plurality of energy consumption levels may be associated with a single operational state. The term “operational state” may be understood to refer, for example, to a state among the active states 602 and the inactive states 604 (see FIG. 6).

The plurality of energy consumption levels may be used to serve different applications and services such as, for example, NR, Enhanced Mobile Broadband (eMBB), Ultra-Reliable Low Latency Communications (URLLC) and massive Machine-Type Communication (mMTC).

A plurality of energy consumption levels may be categorized and configured. Each energy consumption level may be associated with an energy consumption level index, which may uniquely identify the energy consumption level. As described in further detail below, the energy consumption level to be used in a given situation may be based upon an application or a service that is to be in use. Alternatively, the energy consumption level to be used in a given situation may be based upon a use case. A use case may be, for example, a transceiver type, a device type, etc. It should be clear that energy consumption levels indices may be used, for example, for convenient indication by inserting energy consumption level indexing bits in an instruction message.

Each energy consumption level may be associated with a configuration, where the configuration includes values for a plurality of parameters. The parameters may include, for example, transceiver/RF parameters. The parameters may include transmission parameters and/or parameters representative of transmission and/or reception beam widths and directions.

A beam (also referred to as beamforming) may be formed by performing amplitude and/or phase weighting on data transmitted or received by at least one antenna port. A beam may be formed by using another method, for example, adjusting a related parameter of an antenna unit. A beam may include a Tx beam and/or a Rx beam. The transmit (Tx) beam indicates distribution of signal strength formed in different directions in space after a signal is transmitted through an antenna. The receive (Rx) beam indicates distribution of signal strength that is of a wireless signal received from an antenna and that is in different directions in space. Beam information for transmission or reception may include one or more of: a beam identifier; an antenna port(s) identifier; a channel state information reference signal (CSI-RS) resource identifier; a SSB resource identifier; a sounding reference signal (SRS) resource identifier; and other reference signal resource identifier. The parameters associated with a configuration of an energy consumption level may relate to beam configuration, including some or all of the parameters addressed above for a transmission beam and/or reception beam.

In some cases, a given energy consumption level may be associated with a given specific service type. For example, service types may include: eMBB; mMTC; and URLLC. It is known that eMBB focuses on providing higher data-rate transmission compared to previous generations. It is known that mMTC is designed for large-scale machine-to-machine communications, typically for IoT applications. It is known that URLLC aims to provide ultra-reliable, low-latency communication for applications such as autonomous driving. In some cases, one of the parameters for a given configuration associated with a given energy consumption level, may include a specific maximum energy consumption (e.g., maximum transmission power). For example, the specific maximum energy consumption may be the maximum energy consumption for a given operational state associated with the energy consumption level.

In some cases, a given configuration associated with a given energy consumption level may include specific transceiver/RF parameters. The specific transceiver/RF parameters may, for one example, include an indication of a transceiver type, such as a low cost transceiver or a normal transceiver. The specific transceiver/RF parameters may, for further examples, include an indication of a device type, an antenna/MIMO configuration, a plurality of beam weights, transmission parameters and reception parameters.

Switching between different energy consumption levels in a given operational state may be triggered by, or based upon, one or more of a plurality of considerations.

One consideration in switching between energy consumption levels may be Hybrid Automatic Repeat Request (HARQ) feedback. For one example, a device operating according to one energy consumption level, with its associated configuration including transceiver parameters, may receive an instruction to step down its energy consumption level, that is, to operate according to a lower energy consumption level. The instruction may be transmitted, for example, responsive to consistent receipt of HARQ feedback with ACK (Acknowledgement) or responsive to an absence of receipt of NACK (Negative Acknowledgement) from a reception end of a communication session.

For another example, a device operating according to one energy consumption level, with its associated configuration including transceiver parameters, may receive an instruction to step up its energy consumption level, that is, to operate according to a higher energy consumption level. The instruction may be transmitted responsive to receiving HARQ feedback with NACK from a reception end of a communication session.

Another consideration in switching between energy consumption levels may be channel conditions. During wireless communication between a UE and a base station, the base station is typically able to perform channel measurements on communication received from the UE. It may also be expected that the UE may perform channel measurements on communication received from the base station. As a consequence of the channel measurements performed at the UE, the base station may receive, from the UE, channel measurement information. Based on the channel measurements, either performed or received, the base station may transmit an instruction to cause the UE to switch to a new energy consumption level. The transmission of the instruction may be triggered based upon predetermined criteria or predetermined metrics. The criteria or metrics may, for example, be referenced as Key Performance Indicators (KPIs). The KPIs may include, e.g., a signal to interference-and-noise ratio (SINR), a Reference Signal Received Power (RSRP), a multiple-input multiple-output (MIMO) configuration or a set of beam conditions.

Another consideration in switching between energy levels may be a combination of energy consumption and device type. In some cases, different types of devices or UEs may have different power usage limitations or requirements. Based, at least in part, on demand for power, a base station may transmit, to a device, an instruction to switch to a new energy consumption level. The base station may determine the new energy consumption level based, for example, on actual energy consumption, reported by the device, and/or a remaining power headroom reported by the device.

Switching to a new energy consumption level may involve stepping down the energy consumption level or stepping up the energy consumption level.

Stepping down the energy consumption level may involve, for one example, the device switching to operate according to an energy consumption level that is one energy consumption level index below the index of the energy consumption level according to which the device was operating before receiving the instruction to step down.

Stepping down the energy consumption level may involve, for another example, the device switching to operate according to an energy consumption level that is more than one energy consumption level index below the index of the energy consumption level according to which the device was operating before receiving the instruction to step down.

Stepping up the energy consumption level may involve, for one example, the device switching to operate according to an energy consumption level that is one energy consumption level index above the index of the energy consumption level according to which the device was operating before receiving the instruction to step up.

Stepping up the energy consumption level may involve, for another example, the device switching to operate according to an energy consumption level that is more than one energy consumption level index above the index of the energy consumption level according to which the device was operating before receiving the instruction to step up.

Such a switching mechanism may be implemented at a UE and/or at a base station. Notably, the different energy consumption level may be indexed with different energy consumption level indices and a categorized granularity between energy consumption levels may be specifically configured.

In one example of operation, the base station may use semi-static signaling, e.g., RRC/higher layer signaling or media access control-control element (MAC-CE) signaling, to instruct a device to switch to a new energy consumption level. In another example of operation, the base station may use dynamic signaling, e.g., Downlink Control Information (DCI) signaling, to instruct a device to switch to a new energy consumption level. In a further example of operation, the base station may use a combination of semi-static signaling and dynamic signaling to instruct a device to switch to a new energy consumption level. Semi-static signaling usually occurs over a time period longer than several subframes or longer, even, than several radio frames. A semi-static signaling configuration may be understood to relate to a signaling configuration in a protocol layer that is higher than the physical layer. Dynamic signaling usually occurs over a time period equal to, or shorter than, one subframe. Dynamic signaling may be carried out on an on-demand basis. A dynamic signaling configuration usually references a signaling configuration on a physical layer.

The operational states may include the active states 602 and the inactive states 604 (see FIG. 6). The active states 602 may be defined as the operational states suited for transmission or reception of large traffic, e.g., traffic that arrives continuously in a period. The inactive states 604 may be defined as the operational states suited for transmission or reception of relatively less traffic, e.g., traffic that arrives sporadically in a period.

An example active state 602 is the known RRC connected state 610. Two example inactive states 604 are the known RRC inactive state 606 and the known RRC idle state 608 (see FIG. 6).

In some examples, a reference to a plurality of active states 602 may be understood to be a reference to the known RRC connected state 610 and a further active state (not illustrated in FIG. 6). The further active state may, for example, relate to specific devices, UEs, applications or services. Similarly, a reference to a plurality of inactive states 604 may be understood to be a reference to one or more states (not illustrated in FIG. 6) other than the known RRC inactive state 606 and the known RRC idle state 608.

Each operational state may be associated with one energy consumption level or more than one energy consumption level. Distinct energy consumption levels may be used to serve distinct applications and services, such as NR eMBB, URLLC and mMTC, etc.; or to serve different types of devices, such as (normal energy consumption) cell phone, (low energy consumption) electric meter, etc. Each energy consumption level may be associated with a configuration that includes a plurality of parameters for a specific operational state. The parameters may include transceiver/RF information (e.g., transceiver type, such as low cost or normal transceiver, antenna/MIMO configuration, beam steering weights (transceiver parameters), service type and/or other parameters related to energy consumption (e.g., maximum transmission power).

Conveniently, the configuration associated with an energy consumption level includes values for parameters that extend beyond the maximum transmitted power to include transmission parameters and reception parameters, including parameters that are involved in both digital parts and analog parts of the transceiver.

A device may receive an instruction to switch to a new operational state. In some examples, the instruction may be received via semi-static signaling, e.g., using RRC/higher layer signaling or MAC-CE signaling. In other examples, the instruction may be received via dynamic signaling, e.g., using a DCI indication. The base station that transmits, to the device, the instruction to switch to a new operational state may also switch itself to a new operational state. In such a case, this may be called a mutual transition.

A decision to implement a mutual transition of operational states may be based on one factor or based on a variety of factors. Example factors include traffic loading, service type, UE type and energy consumption criteria.

For example, a given low cost device may generally stay in one of the inactive states 604. The given low cost device may only occasionally receive an instruction to switch to one of the active states 602 to handle certain traffic that requires higher power operation. The given low cost device may then receive an instruction to switch back to one of the inactive states 604 after the higher power operation is complete or it may switch back to one of the inactive states 604 after, for example, a specific period of time (time-out).

A given example UE may experience a first rate of switching between energy consumption levels within a given operational state. The given example UE may also experience a second rate of switching between operational states. The first rate of switching (between energy consumption levels) may be carried out, for example, responsive to changes in (at least) the wireless environment of the given example UE. The second rate of switching (between operational states) may be carried out responsive to changes in traffic handled by the given example UE and applications executed by the given example UE. An energy consumption level may be used to support data transmission and/or data reception. It follows that an energy consumption level may be changed responsive to changes in the wireless and mobile environment. An operational state, on the other hand, may be related to application type and the traffic variation associated with the application type. Usually, the changes in (at least) the wireless environment of the given example UE may be faster than the changes in traffic handled by the given example UE and applications executed by the given example UE. It follows, then, that the first rate of switching is expected to be higher than the second rate of switching.

In one example implementation of aspects of the present application, parameters in a configuration associated with an energy consumption level may include transceiver information, an indication of a service type and an indication of a maximum transmission power. The energy consumption level may be associated with a particular operational state, e.g., one of the active states 602 or one of the inactive states 604.

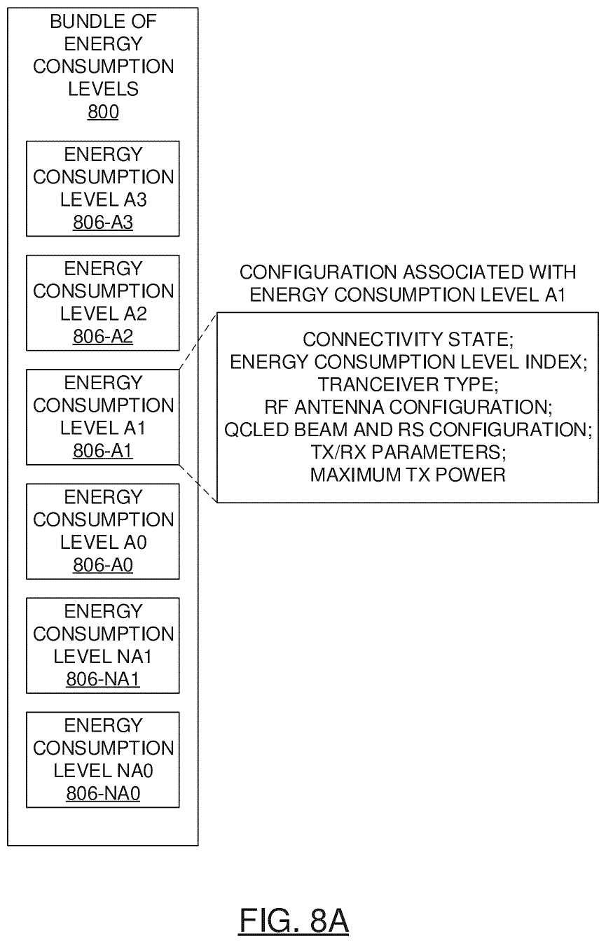

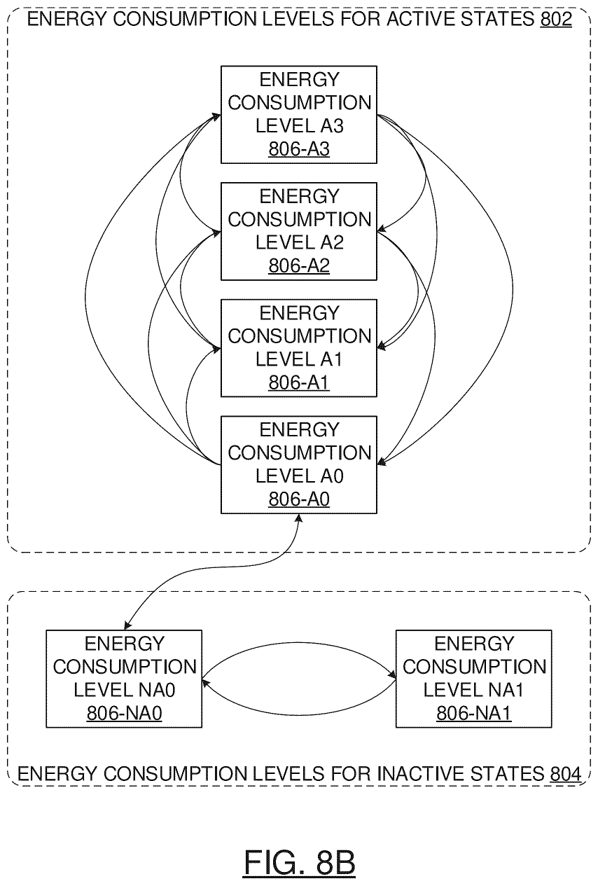

It should be noted that there is not, necessarily, a one-to-one mapping between energy consumption levels and operational states. There may, for example, be four energy consumption levels associated with a first operational state and two energy consumption levels associated with a second operational state (see FIG. 8A and FIG. 8B). It follows that, when a UE receives an instruction to switch from an original operational state to a destination operational state, the instruction will also specify an energy consumption level associated with the destination operational state. It also follows that, when a UE receives an instruction to switch from an original energy consumption level to a destination energy consumption level, the instruction need not specify a destination operational state, since there will be only one operational state associated with the destination energy consumption level.

According to aspects of the present application, a device may be instructed to switch to a particular energy consumption level, among a plurality of energy consumption levels, where the particular energy consumption level is well-suited to the current operation of the device. It should be clear that a greater number of distinct energy consumption levels is associated with a finer granularity of coverage or energy consumptions for distinct operations of the device, thereby supporting varying traffic loads, varying applications, and/or different wireless environments, while allowing for power to be used in a manner that is more efficient than conventional approaches.

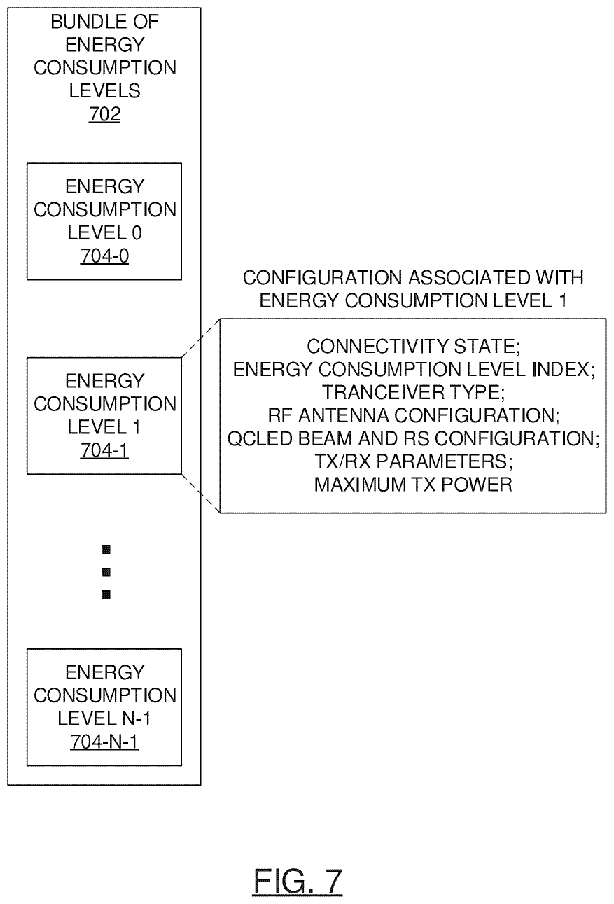

An example bundle of energy consumption level configuration information 702 is illustrated in FIG. 7. The bundle of energy consumption level configuration information 702 is illustrated as including a plurality of energy consumption levels, including a zeroth energy consumption level 704-0, a first energy consumption level 704-1 and an N−1th energy consumption level 704-N−1. The device may receive, from a base station, initial configuration information. The initial configuration information may provide an indication of the plurality of energy consumption levels and the associated configurations, such as the example bundle of energy consumption level configuration information 702, as illustrated in FIG. 7.

An example configuration associated with the first energy consumption level 704-1 is illustrated, in FIG. 7, as including: an operational state; an energy consumption level index; a transceiver type; an RF antenna configuration; a quasi-co-located (QCLed) beam configuration and reference signal (RS) configuration; Tx/Rx parameters; and a maximum transmission power. Examples for the operational state include active state(s) and inactive state(s) such as those illustrated in FIG. 6. The energy consumption level index may, for example, be referenced as a parameter, i. A single bit or a plurality of bits may be used to express the parameter, i. Examples of the transceiver type include a wake-up signal (WUS) transceiver and a main (MR) transceiver. An example RF antenna configuration may, for one example, be understood to include MIMO parameters. Examples of Tx/Rx parameters include a parameter representative of an MCS, a parameter representative of a waveform and a parameter representative of a carrier.

A specific energy consumption level can be indicated by an energy consumption level indicator that may be carried in a message. Energy consumption levels associated with a given operational state can be categorized or divided into a number (N) of levels. Accordingly, indexing of levels, from 0 to N−1, may be denoted using one or more bits.

A number, J, of energy consumption levels may be associated with an active state.

The energy consumption levels of the active state may be referenced using a term, P_{a_j}, where j=0, 1, . . . , J−1.

Similarly, a number, I, of energy consumption levels may be associated with an inactive state.

The energy consumption levels of the inactive state may be referenced using a term, P_{na_i}, where i=0, 1, . . . , −1.

It should be clear that an energy consumption level index with M-bits may be used to reference up to 2^{M} energy consumption levels for an operational state.

Notably, the terms P_{a_j} and P_{na_i} may be used to indicate an energy consumption level that, as described above, is associated with a configuration of transceiver information, service type, transmission parameters (including maximum transmission power) and other factors that are described above or hereinafter.

As discussed hereinbefore, a given energy consumption level may be associated with a given operational state. The given energy consumption level may be indicated in the context of the given operational state. It follows that the given energy consumption level may be configured in view of the given operational state. The given operational state may be an active state, such as the known RRC connected state described above. Alternatively, the given operational state may be an inactive state, such as the known RRC inactive state or the known RRC idle state as described above.

An active state may be considered to be an operating state well suited for transmission or reception of large traffic, e.g., traffic that arrives continuously in a period. By configuring more than one energy consumption level for an active state, it may be shown that support is, thereby, provided for different types of traffic and/or different types of devices with energy consumptions in the active state.

An inactive state may be considered to be an operating state well suited for transmission or reception of less traffic, e.g., traffic that arrives sporadically in a period. By configuring more than one energy consumption level for the inactive state, it may be shown that support is, thereby, provided for different types of traffic and/or different types of devices with energy consumptions in the inactive state.

In some embodiments, an energy consumption level may be associated with a given transceiver type and RF configuration. An energy consumption level may be indicated in the context of a given transceiver type and RF configuration. An energy consumption level may be configured in view of a given transceiver type and RF configuration. An energy consumption level may be associated with transceiver information configuration. Transceiver information configuration may indicate, for example, a low-cost type transceiver or a normal type transceiver. Transceivers can include, at a device end, wake-up receivers (WURs) and main receivers (MRs, which are legacy or normal transceivers). Transceivers can include, at a base station end, a low-power wake-up signal (LP-WUS) transceivers and normal (or legacy) transceivers. In some cases, a low-cost transceiver may be used for operation in inactive state(s) and a normal transceiver may be used for operation in active state(s). In other cases, a device operating in an active state may use any one, or both, of a low-cost transceiver and a normal transceiver. A device may be configured semi-statically, e.g., by RRC/higher layer signaling or by MAC-CE signaling. A device may be configured dynamically, e.g., by downlink control information (DCI) signaling. Configuring a device may involve transmitting an instruction specifying an energy consumption level.

In other embodiments, an energy consumption level may be associated with an antenna configuration. An antenna configuration may be defined on the basis of, e.g., n transmitter antennas in combination with m receiver antennas, with n and m configured using higher level signaling or using Li or physical layer signaling, where the antenna configuration may include beam steering weight parameters for beam directional transmission or reception.

An energy consumption level may be associated with a given QCLed beam configuration and/or a given RS configuration. The given QCLed beam configuration may be derived from a previously, or concurrently, received signal on a beam where a signal transmitted on the given QCL beam is expected to experience a same channel condition or a similar channel condition as the received signal. Similarly, a transmission may include a reference signal (RS), such as demodulation RS, which may be used to help predict channel conditions. It follows that the RS configuration, along with the QCLed beam configuration, may work more efficiently on the estimation of the channel of interest and enhance the data reception at the receiver end. An energy consumption level may be indicated in the context of a given QCLed beam configuration and/or RS configuration. An energy consumption level may be configured in view of a given QCLed beam configuration or in view of an RS configuration. QCLed beam configurations may include beam indices, beam directions, reference signals associated with specific beams and antenna port information. Reference signals (RSS) may be QCLed with each other such that a relationship exists between RSs associated with different beams and/or different transceiver types. For example, one RS transmitted by a low-power transceiver and another RS transmitted by a legacy transceiver may both be transmitted from a same transmission end and, thus, it is expected that the two RSs will have a QCLed relationship. As a result, the QCLed RSs can be mutually beneficial, at the reception end, for a channel estimation procedure and for a signal detection procedure in relation to either the low-power transceiver or the legacy transceiver. In some cases, information determined based upon reference signals received at a normal transceiver may assist in the detection of reference signals at a low-cost transceiver. In these cases, the QCL content, e.g., pass-loss or doppler coupling, may be defined or configured in a manner that supports the applications cross beams, transceivers and/or bandwidth parts.

An energy consumption level may be associated with given transmission parameters and/or given reception parameters. An energy consumption level may be indicated in the context of given transmission parameters and/or given reception parameters. An energy consumption level may be configured in view of given transmission parameters and/or given reception parameters. The transmission parameters and the reception parameters may be related to the energy consumption level and may help to establish a variety of energy consumption categories. The transmission or reception parameters may include a modulation and coding scheme (MCS) parameter. Further parameters may include a signal waveform type parameter indicative of, e.g., an OFDM signal waveform type, a single-carrier signal waveform type, a non-OFDM signal waveform type, etc. Further parameters may include a carrier frequency band parameter and a bandwidth part parameter. MCS parameters may include parameters related to modulation type, coding rate, spatial streams, channel width and guard interval.

An energy consumption level may be associated with a given maximum transmission power. An energy consumption level may be indicated in the context of a given maximum transmission power. An energy consumption level may be configured in view of a given maximum transmission power. The maximum transmission power may be configured differently for a different energy consumption level. Sometimes, the maximum transmission power configuration may be related to the device type or related to the network node type. The maximum transmission power configuration may be related to the application type or related to the service type. The maximum transmission power configuration may be related to mobility and environment.

FIG. 8A and FIG. 8B schematically illustrate a plurality 802 of active energy consumption levels, for active states, and a plurality 804 of non-active (NA) energy consumption levels, for inactive states. The schematic illustration of energy consumption levels allows for a discussion of switching between energy consumption levels. The plurality 802 of active energy consumption levels for active states includes a zeroth active energy consumption level 806-A0, a first active energy consumption level 806-A1, a second active energy consumption level 806-A2 and a third active energy consumption level 806-A3. The plurality 804 of non-active energy consumption levels for inactive states includes a zeroth non-active energy consumption level 806-NA0 and a first non-active energy consumption level 806-NA1.

An example configuration associated with the first active energy consumption level 806-A1 is illustrated, in FIG. 8A, as including: an operational state; an energy consumption level index; a transceiver type; an RF antenna configuration; a QCLed beam and RS configuration; Tx/Rx parameters; and a maximum transmission power.

Switching between energy consumption levels may be carried out in many ways. For example, switching between energy consumption levels may be carried out at a UE, at a network node, or at both a UE and a network node. There may be a time gap between a switching instruction or indication signaling and starting to operate at a new energy consumption level, where the time gap value may be configurable as a higher layer parameter. This higher level parameter may be, for example, configured by a higher layer signaling, such as RRC or MAC-CE, or may be included in the switching instruction or indication signaling, such as DCI.

Switching between energy consumption levels may be triggered by one or more factors. These factors may include: HARQ feedback; channel measurement conditions; performance metrics, such as block error rate (BLER); throughput; bandwidth switching; and carrier band switching.

Switching between energy consumption levels may, for example, be triggered based on HARQ feedback or as a function of ACK/NACK within a certain period. In one example, a configurable consecutive number of ACKs in a configurable period may trigger switching to a lower energy consumption level. In another example, a configurable consecutive number of NACKs in a configurable period may trigger switching to a higher energy consumption level. In other cases, the switching between energy consumption levels may be based on a configurable count of ACKs and a configurable count of NACKs in a configurable period, where a relative relationship between the configurable count of ACKs and the configurable count of NACKs can be configured and used to trigger a switching. For example, if the number of ACKs is greater than the number of NACKs in the configurable period, switching may be triggered to switch to a lower energy consumption level. If the number of ACKs is lesser than the number of NACKs in the configurable period, switching may be triggered to switch to a higher energy consumption level. In this case, the switching between energy consumption levels may be considered to be based on a statistical channel quality.

A switch between energy consumption levels may, for example, be implemented as a switch from one energy consumption level to a next immediately lower energy consumption level, for example, in view of FIG. 8B, from the second active energy consumption level 806-A2 to the first active energy consumption level 806-A1.

A switch between energy consumption levels may, for another example, be implemented as a switch from one energy consumption level to a next immediately higher energy consumption level, for example, in view of FIG. 8B, from the second active energy consumption level 806-A2 to the third active energy consumption level 806-A3.

A switch between energy consumption levels may, for a further example, be implemented as a switch from one energy consumption level to any other energy consumption level, for example, in view of FIG. 8B, from the zeroth active energy consumption level 806-A0 to the third active energy consumption level 806-A3.

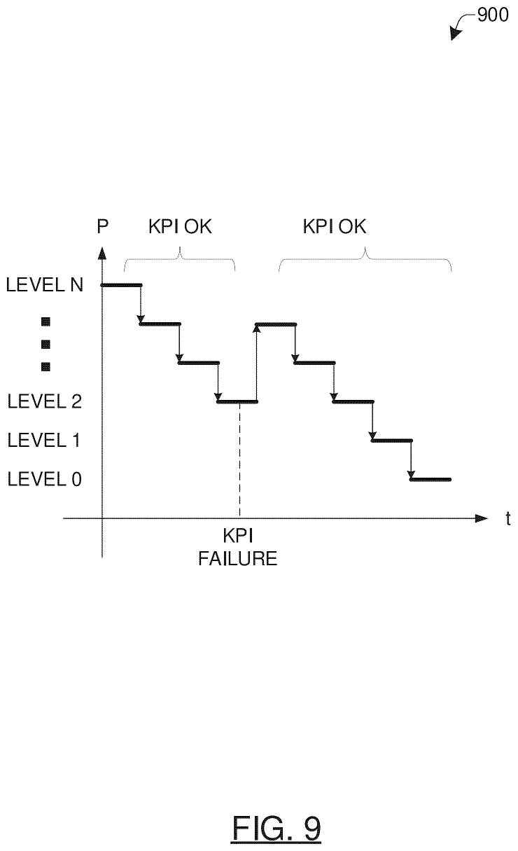

That is, it should be clear that the result of the switch is not limited to the next immediately lower energy consumption level or the next immediately higher energy consumption level. A device may, in some cases, be instructed to switch incrementally, to a slightly lower energy consumption level, responsive to receiving a single ACK. A device may, in some cases, be instructed to switch broadly, to a significantly higher energy consumption level, responsive to receiving, at the reception end, a single NACK. These example switches are illustrated in a timeline plot 900 of energy consumption level against time in FIG. 9, wherein switching between energy consumption levels is illustrated for a device in an active state. The illustration in FIG. 9 includes a reference to KPIs. KPIs may be considered to be performance metrics, also called key performance indicators (KPIs), such as user (perceived) throughput, cell throughput, latency, channel quality (that provides more details on channel measurements in the following), device type and capability, etc. KPIs may be pre-defined, pre-configured or configured by the network.

At the beginning of the timeline plot 900 represented in FIG. 9, a device is operating at an active energy consumption level N. That is, the device is performing a communication between the device and a network entity using the values for the parameters included in the configuration associated with the active energy consumption level N. As KPIs remain OK, the device may receive an instruction to commence operating in an active energy consumption level N−1. The device may respond to the instruction by commencing operation in the active energy consumption level N−1. That is, the device commences performing communication between the device and a network entity using the values for the parameters included in the configuration associated with the active energy consumption level N−1. As KPIs remain OK, the device may receive further instructions to commence operating in a lower active energy consumption level. FIG. 9 illustrates that, while operating in the active energy consumption level A2, the device experiences a KPI failure. As a consequence of reporting that a KPI failure has occurred, the device may receive an instruction to commence operating in the active energy consumption level N−1. The device may respond to the instruction by commencing operation in the active energy consumption level N−1. That is, the device commences performing communication between the device and a network entity using the values for the parameters included in the configuration associated with the active energy consumption level N−1. As KPIs remain OK, the device may receive further instructions to commence operating in a lower active energy consumption level. In the timeline plot 900 illustrated in FIG. 9, the KPIs remain OK and the device eventually operates in an active energy consumption level A0. That is, the device performs communication between the device and a network entity using the values for the parameters included in the configuration associated with the active energy consumption level A0.

Switching between energy consumption levels may, for example, be triggered based on channel measurements, triggered based on environment conditions or triggered as a function of different channels used or/and channel measurements. In the latter case, for example, the channels to be measured may include cell-common and UE-specific channels for either control transmissions or data transmissions. The measured signals can be system information such as a SSB, DMRS, CSI-RS, uplink (UL) sounding signal, etc.

Switching between energy consumption levels may, for example, be triggered responsive to other performance metrics. The other performance metrics may include block error rate and throughput. Switching between energy consumption levels may, for example, be triggered responsive to other communication switching, including bandwidth switching and/or carrier band switching, etc. Moreover, beam switching or beam-width configuration change for a UE or a group of UEs may also be associated with switching between energy consumption levels.

Switching between energy consumption levels may, for example, be implemented through use of an energy consumption level indication or an energy consumption level indicator. An instruction to switch between energy consumption levels may be interpreted, by a device receiving the instruction, as an indication that a current energy consumption level, with active operation, is to be deactivated and a new energy consumption level is to be activated as a new active operation. When switching between energy consumption levels is implemented through use of signaling, the signaling may be accomplished using dynamic (e.g., Layer 1 or physical layer) signaling or using semi-static (e.g., higher layer) signaling.

One example of implementing switching between energy consumption levels through use of signaling may be referenced as “UE-specific-based DCI.” It is known for a UE to receive DCI as part of a scheduling process. It is proposed herein that one or more new fields may be added to the DCI for use to instruct a UE to commence switching to a new energy consumption level from a current energy consumption level. Alternatively, it is proposed herein that one or more existing fields of the DCI may be modified for use to instruct a UE to commence switching to a new energy consumption level from a current energy consumption level. One or more bits may be used to indicate the new energy consumption level. Indeed, the number of bits that are used to indicate the new energy consumption level may depend on a quantity of energy consumption levels that have been defined, categorized or configured for a given operational state.

Another example of implementing switching between energy consumption levels through use of signaling may be referenced as “cell-common-based DCI” or “group-based DCI.” It is known for a group of UEs to receive DCI as part of a scheduling process or to receive messages as part of system information broadcasting. It is proposed herein that new information may be included in a system information message, such as an SSB, for use to instruct a UE to commence switching to a new energy consumption level from a current energy consumption level. Alternatively, it is proposed herein that new information may be included in a group-common control signaling message, such as a paging DCI or a paging message, for use to instruct a UE to commence switching to a new energy consumption level from a current energy consumption level. One or more bits can be used to indicate the new energy consumption level. The number of bits that are used to indicate the new energy consumption level may depend on a quantity of energy consumption levels that have been defined, categorized or configured for a given operational state.

A further example of implementing switching between energy consumption levels through use of signaling may be referenced as “RRC”. That is, semi-static control signaling may be used to re-configure a device to use a new energy consumption level after deactivating an active operation at a current energy consumption level. The RRC (signaling) is a higher layer signaling.

A further example of implementing switching between energy consumption levels through use of signaling may be referenced as “MAC-CE.” That is, it is proposed herein to imbed semi-static signaling in data traffic, e.g., using a MAC sub-header and control element. The embedded semi-static signaling may be used to re-configure a device to use a new energy consumption level after deactivating an active operation at a current energy consumption level.

As discussed hereinbefore, operational states may include active states and inactive states. An example active state is RRC connected state. Example inactive states include RRC inactive state and RRC idle state. In some examples, the active states may include one connected state and one or more other active states. The one or more other active states may apply, for example, for some devices, UEs, applications or services. Similarly, the inactive states may include one or more states other than the RRC inactive state and the RRC idle state.

Each operational state may be associated with a single energy consumption level or multiple energy consumption levels that may be used to serve different applications and services, such as eMBB, URLLC and mMTC. As discussed hereinbefore, each energy consumption level may be associated with a configuration with transceiver/RF information (e.g., transceiver type, such as low cost transceiver or normal transceiver, antenna/MIMO, beam weights in antenna configurations for steering the beam directions, transmission and reception parameters), service type and/or transmission power (e.g., maximum transmission power) for a given operational state. In some examples, switching between operational states is known to be triggered based on changes detected in transceiver types, traffic types, traffic loading, Quality of Service (QoS), etc. Moreover, an operational state transition period may be configured. The operational state transition period may establish a duration for a transition between operational state transition signaling being indicated and the operational state transition being actually performed.

The operational states may be mutually transitioned or switched.

An instruction to switch operational states may be signaled using semi-static signaling, e.g., using RRC/higher layer signaling (e.g., using an RRC-reconfiguration message), using MAC-CE signaling or/and using dynamic signaling, e.g., signaling DCI indication.

An operational state transition may be triggered based on, for example, traffic loading, service type, UE type and energy consumption criteria. For example, a low cost device may generally stay in an energy consumption level among the energy consumption levels associated with an inactive state. In view of FIG. 8B, consider that the low cost device may generally stay in the zeroth non-active energy consumption level 806-NA0 among the second plurality 804 of energy consumption levels for inactive states.

Only occasionally, the low cost device may receive an instruction to switch to an active state for certain traffic that requires a higher energy consumption level and then switch back to the inactive state. Accordingly, the low cost device may switch to the zeroth active energy consumption level 806-A0 among the first plurality 802 of energy consumption levels for active states.

In some examples, MAC-CE may be used with a header that includes the instruction to implement an operational state transition and a transition duration (or gap). The transition duration may be understood to provide a buffering time period to allow time for a device to establish a readiness for the operational state transition. The instruction to implement the operational state transition may be accompanied by new energy consumption level indication. An RRC-reconfiguration message may include an energy consumption level indication or an energy consumption level indicator. The energy consumption level and indexing may be selected from among a configured set of energy consumption levels. At least one energy consumption level may be established as a default energy consumption level (e.g., an initially used energy consumption level). Optionally, DCI may be used to signal an energy consumption level indication.

For inactive states, more than one energy consumption level (see FIG. 8B) may be used to support a variety of applications, services, QoS or device types.

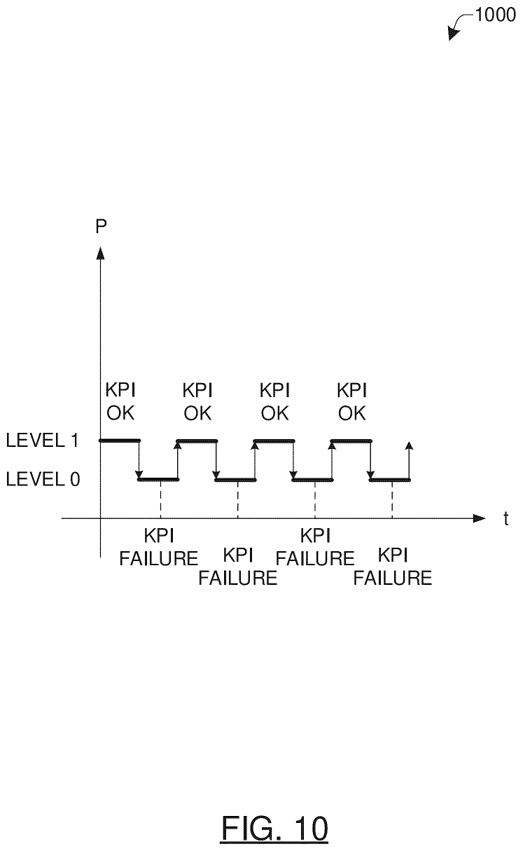

FIG. 10 illustrates a timeline plot 1000 of energy consumption level against time for a device operating in an inactive state, such as Inactive or Idle state, in accordance with aspects of the present application.

At the beginning of the timeline plot 1000 represented in FIG. 10, a device is operating at a non-active energy consumption level NA1. That is, the device is performing communication between the device and a network entity using the values for the parameters included in the configuration associated with the non-active energy consumption level NA1. As KPIs remain OK, the device may receive an instruction to commence operating in a non-active energy consumption level NA0. The device may respond to the instruction by commencing operation in the non-active energy consumption level NA0. That is, the device commences performing communication between the device and a network entity using the values for the parameters included in the configuration associated with the non-active energy consumption level A0. FIG. 10 illustrates that, while operating in the non-active energy consumption level NA0, the device experiences a KPI failure. As a consequence of reporting that a KPI failure has occurred, the device may receive an instruction to commence operating in the non-active energy consumption level NA1. The device may respond to the instruction by commencing operation in the non-active energy consumption level NA1. That is, the device commences performing communication between the device and a network entity using the values for the parameters included in the configuration associated with the non-active energy consumption level NA1. As KPIs remain OK, the device may receive further instructions to commence operating in the non-active energy consumption level NA0. The device may respond to the instruction by commencing operation in the non-active energy consumption level NA0. That is, the device commences performing communication between the device and a network entity using the values for the parameters included in the configuration associated with the non-active energy consumption level NA0. In the timeline plot 1000 illustrated in FIG. 10, the device repeatedly experiences a KPI failure while operating in the non-active energy consumption level NA0 and receives instructions to commence operating in the non-active energy consumption level NA1. As KPIs remain OK, the device subsequently receives further instructions to commence operating in the non-active energy consumption level NA0.

As discussed hereinbefore, inactive states are expected to be used to handle lower amounts of traffic than the amounts of traffic handled by a device in an active state. However, a device in an inactive state may still need to monitor for network information and channel conditions.

It follows that more than one energy consumption level may be defined for a particular inactive state. It may be shown that, by defining more than one energy consumption level, allowance may be made for UE monitoring and paging detection on DL notification, for example, with a low-cost transceiver or a normal transceiver. Moreover, an inactive state may operate with an energy consumption level associated with a low-cost transceiver, a normal transceiver or both, in which an energy consumption level can be configured to work with a different transceiver type and associated different transmission and reception parameters.

In some cases, a rate of switching between energy consumption levels in an operational state may be faster than a rate of switching between operational states, say, between an active state and an inactive state. This rate difference can be due to the fact that a change of wireless and mobile environment may be faster than traffic and application variation. This rate difference follows given that an energy consumption level is more related to supporting the data transmission or reception in the wireless and mobile environment, while an operational state is more associated with application type and its traffic variation that could change more slowly.

Aspects of the present application relate to a given UE transmitting, to a base station, an indication of a proposed energy consumption level, among the plurality of energy consumption levels with which the UE has been configured. The UE may operate with an energy consumption level until a receipt of approval to switch to the proposed energy consumption level. Upon receiving the approval, the UE may implement a switch to the proposed energy consumption level.

Aspects of the present application relate to triggering switching between energy consumption levels in an intelligent way. For example, the timing of a switch from one energy consumption level to another energy consumption level may be determined by an inference generated using a scheme based on machine learning (ML).

An ML-based inference scheme may be expected to be prepared using training. The training may be local training. That is, the training may occur at the scale of a specific device or UE. The training may be global training. That is, the training may occur at the scale of a network.

An ML-based inference scheme may allow for determining a manner in which energy consumption levels impact wireless performance. Wireless performance may, for example, be measured in terms of a block error rate (BLER), in terms of throughput, in terms of a signal-to-interference-and-noise ratio (SINR), etc. Reference signals, such as SSB, CSI-RS, demodulation reference signal (DMRS), etc., may be configured with different power or power density for resource elements. After training at the device/UE side, at the network side or at both sides, wireless performance may be determined, by the ML-based inference scheme, to change as a function of energy consumption level or as a function of power spectral density in resource elements. In this way, an inference from the ML-based inference scheme may be obtained to improve decisions to switch between energy consumption levels under certain trained conditions.

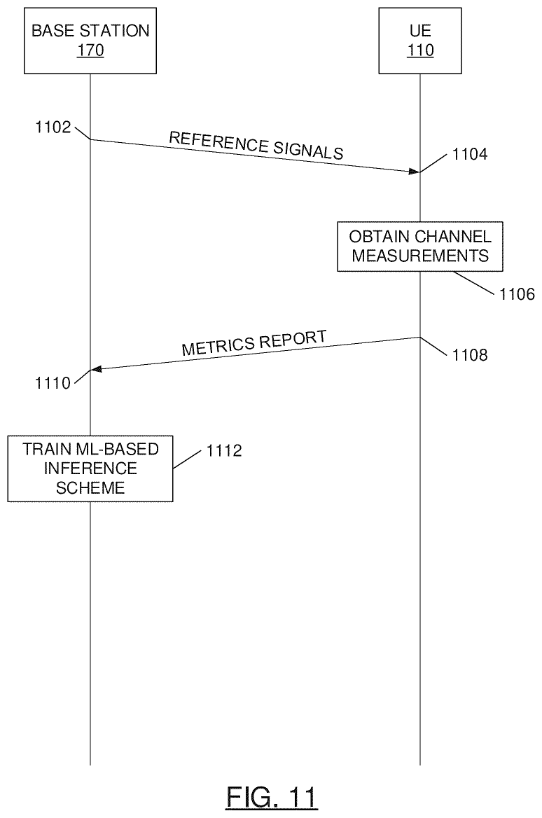

FIG. 11 illustrates, in a signal flow diagram, a BS-side, downlink-based training scenario, wherein a base station 170 may transmit (step 1102) a plurality of reference signals (over beams). The reference signals may be distinguished from each other on the basis of power distribution, measurement metric and/or reporting channel. Responsive to receiving (step 1104) the reference signals, a UE 110 may obtain (step 1106) channel measurements. More specifically, the UE 110 may obtain power-related, performance-impact metrics, e.g., interference, SINR BLER, etc. The UE 110 may then provide (step 1108), to the BS 170, a report that includes indications of the power-related, performance-impact metrics.

The base station 170 may train (step 1112) an ML-based inference scheme based on the report received (step 1110) from the UE 110. The training (step 1112) of the ML-based inference scheme may occur online or offline. The training (step 1112) of the ML-based inference scheme may occur periodically (that is, with a defined period duration) or intermittently (that is, in the absence of a defined period duration). The result of training (step 1112) the ML-based inference scheme may be the obtaining of inference information and control information. An example of the inference information and the control information may be a relationship between a transmission power, employed at the base station 170, and a given performance metric, measured at the UE 110.

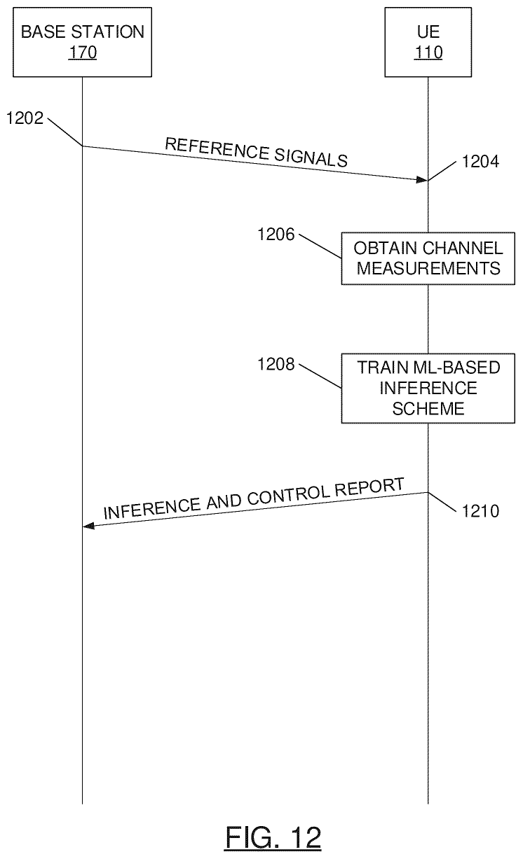

FIG. 12 illustrates, in a signal flow diagram, a UE-side, downlink-based training scenario, wherein a base station 170 may transmit (step 1202) a plurality of reference signals (over beams). The reference signals may be distinguished from each other on the basis of power distribution, measurement metric and/or reporting channel. Responsive to receiving (step 1204) the reference signals, a UE 110 may obtain (step 1206) channel measurements. More specifically, the UE 110 may obtain power-related, performance-impact metrics, e.g., interference, SINR BLER, etc. The UE 110 may then feed the power-related, performance-impact metrics into an ML-based inference scheme to, thereby, perform (step 1208) local training. In a manner consistent with the BS-side, downlink-based training scenario, the training (step 1208) of the ML-based inference scheme may occur online or offline and may occur periodically (that is, with a defined period duration) or intermittently (that is, in the absence of a defined period duration).

The result of training (step 1208) the ML-based inference scheme may be the obtaining of inference information and control information. An example of the inference information and control information may be a relationship between a transmission power, employed at the base station 170, and a given performance metric, measured at the UE 110.

Upon obtaining the inference information and the control information, the UE 110 may transmit (step 1210), to the base station 170, a report. The report may include the inference information and the control information.

Optionally, the base station 170 may perform training based on reporting received from the UE. Accordingly, the base station 170 may obtain an inference for a switch between downlink energy consumption levels over the achievable performance metric.

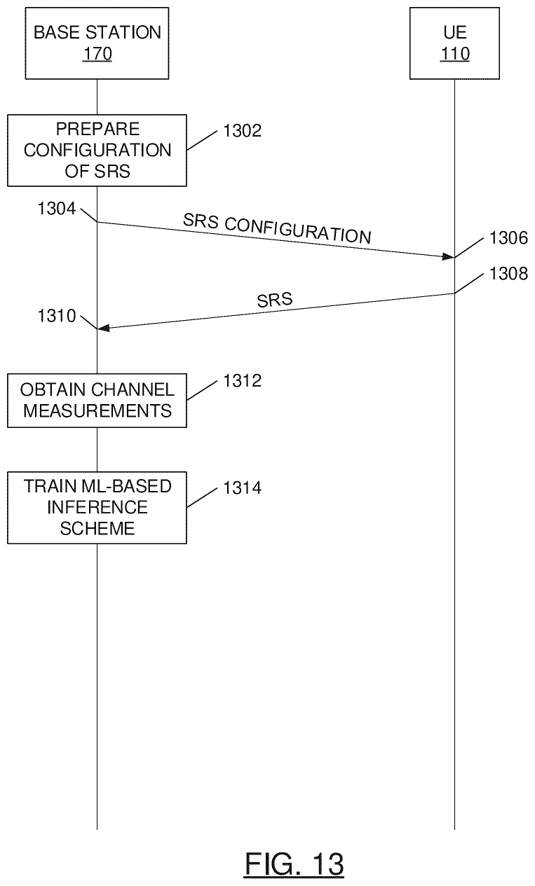

FIG. 13 illustrates, in a signal flow diagram, a network-side, uplink-based training scenario, wherein a base station 170 may prepare (step 1302) a configuration for a plurality of sounding reference signals (over beams). The base station 170 may then transmit (step 1304) the configuration to a UE 110. The sounding reference signals (SRS) may be distinguished from each other on the basis of power distribution, measurement metric and/or reporting channel. Subsequent to receiving (step 1306) the configuration, the UE 110 may transmit (step 1308) the SRS.

Responsive to receiving (step 1310) the SRS, the base station 170 may obtain (step 1312) channel measurements. More specifically, the base station 170 may obtain power-related, performance-impact metrics, e.g., interference, SINR BLER, etc. The base station 170 may then feed the power-related, performance-impact metrics into an ML-based inference scheme to, thereby, perform (step 1314) network-based training. In a manner consistent with the BS-side, downlink-based training scenario, the training (step 1314) of the ML-based inference scheme may occur online or offline and may occur periodically (that is, with a defined period duration) or intermittently (that is, in the absence of a defined period duration).

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

Power saving in current networks may be done by a way of RRC (Radio Resource Control) state transition. Different RRC states (such RRC connected state, Inactive state and Idle state) may have different power consumptions related to, for example, a limitation of the transmission or reception behaviors/activities, monitoring/sending network messages, and/or measurement and reporting occasions. The state transitions among these power saving approaches may limit the time-frequency resource usage while the transceiver parameters, such as antenna configurations, may not be directly involved. As a result, current power saving schemes are basically a reduction of operations in using time-frequency resources with a possibility of silent or sleep operations. These apply to both a UE and a base station.

A legacy network, such as NR (New Radio), has three RRC states for a UE: RRC connected, Inactive and Idle states, which is shown in FIG. 6.

In the legacy network, a different RRC state of a UE may perform different transmission and/or reception activities. For example, in FIG. 6, the RRC connected state can operate with full transmission and/or reception activities, including the transmission or reception behaviors, monitoring/sending network messages, and/or measurement and reporting occasions. The RRC Idle state does not transmit any traffic while monitoring limited system or network messages. The RRC Inactive state can keep some necessary network configurations for faster state transition to the RRC connected state or a transmission or reception of (possibly short) control or data messages between the UE and a base station, on top of the operation behaviors of the RRC Idle state.

From the network perspective, a base station may have to deal with more than one UE, and thus the base station may have to support the operations for each UE with different RRC states. The base station may be saving power consumption by sending a reduced number of system messages such as SSB (system synchronization block), paging, etc.; or entering into a sleep mode (e.g., no transmission and reception operations) without supporting any UE within the BS (base station). Obviously, such network power saving is at a cost of overall network performance, as the reduced number of system messages such as SSB or paging may lead to a delay in support of UE operations or to a situation that a UE is not able to be supported during a network/base station sleep mode.

Current networks don't consider an association of power consumptions in an RRC state with specific transceiver and transmission parameters (note that in this patent, “transmission parameters” may comprise parameters of transmission, reception or both), in another word, there is no finer power consumption level categorization and control, and thus there is no specific meaning on power (consumption) levels in terms of categorizations of accurate power consumptions. Moreover, there is no specific power-level switching mechanism or criteria over different (operation) power levels and/or over different RRC states in relation to more accurate power consumption and control. In future wireless networks, it may be required or demanded that the power saving can be finely controlled on demand, as well as naturally in the sense of an intelligent way.

This application proposes, for example, to resolve on demand and more accurate power level consumptions in a connectivity state that can be represented by power level indicators/indications in the connectivity state, where a power level indictor associated with the connectivity state includes transceiver configuration and other transmission (or communication) parameters.

This application proposes, for example, on-demand power saving with more accurate power level consumptions with two-layer information configurations: a configuration on power-level consumption that is associated with a connectivity state, and a configuration for a power-level indicator (or indication) that is associated with transceiver and transmission parameters. A power level in this patent may indicate or include a power consumption of an operation to support traffic transmission and reception in UE and/or network end. The term power level will be used interchangeably with the term energy consumption level.

On one hand, operation power levels (or “power levels” for simple notation in some places) are associated with one RRC state or connectivity state including, for example, active state(s) and non-active state(s). On the other hand, one connective state is associated with multiple power levels that are used to serve different applications and services such as NR (New Radio) eMBB (Enhanced Mobile Broadband), URLLC (Ultra-Reliable Low Latency Communications) and mMTC (massive Machine Type Communication), and other applications.

The number of power levels can be categorized and configured into multiple levels, indicated using a power level index, which can be based on applications or use cases such as transceiver types, device types, etc., and a power-level indexing can be used, for example, for convenient indication with indexing bits in a message.

Each power-level indicator may be associated with a set of transceiver/RF (radio frequency) and transmission parameters, where the transceiver/RF parameters may include configurations on transmission and/or reception beam widths and directions. In some cases, a power-level indication or a power-level indicator may be associated with transceiver/RF info (e.g., transceiver type such as low cost or normal transceiver, device type, antenna/MIMO, beam weights, transmission and reception parameters), service type, and/or maximum power consumption (e.g., max transmission power) for a connectivity state.

Switching between different power levels in a connectivity state can be triggered by or based on one or more of following considerations:

HARQ (Hybrid Automatic Repeat Request) feedbacks: for example, an operation power level can be slowly reduced with associated transceiver and transmission parameters upon HARQ feedback with ACK (Acknowledgement) or without receiving NACK (Negative Acknowledgement) from the reception end, where the slowly reduced power level can be, for example, reducing the power level by one level or to a power level immediately below the current power level. An operation power level can be quickly increased with associated transceiver and transmission parameters upon HARQ feedback with NACK, where the quickly increased power level can be, for example, increasing the power level by one or more levels or to a power level one or more levels above the current power level. Such a mechanism can be applied to any of UE and base station for power saving. Note that the different power levels can be indexed with power-level indices and the categorized granularity between power levels can be configured.

Channel condition(s): During the wireless communication, either a UE or a base station is able to perform channel measurement or receive channel measurement information from the UE. Based on the channel measurements, operation power levels can be changed or switched using certain criteria or metrics, for example, based on configured reference KPIs (Key Performance Indicators), e.g., SINR (signal to interference & noise ratio), RSRP (Reference Signal Received Power), MIMO (multiple-input multiple-output), beam conditions.

In an intelligent way: An intelligent way may use the ability to learn and/or use reasoning to make decisions, for example, through machine learning (ML). The power levels can be changed or triggered to change in an intelligent way, for example, based on ML inference from ML training and algorithms that are applied to any one end or more ends of UE(s) and base station(s).

Power consumption and device type: in some cases, different types of devices or UEs may have different power usage limitations or requirements, based on demand, operation power levels can be changed or switched based on actual power consumptions and/or power headroom left in a device.

Operation power levels can be changed or switched in a semi-static way, e.g., via RRC signaling, MAC-CE; or in a dynamic way, e.g., via DCI (Download Control Indicator); or a combination of semi-static and dynamic way. A semi-static basis usually means a time period that can be longer than several subframes or even several radio frames, and a semi-static signaling configuration usually means a signaling configuration from a protocol layer higher than physical layer. A dynamic basis usually means a time period that can be equal to or shorter than one subframe, or means an on-demand basis; a dynamic signaling configuration is usually means a signaling configuration from physical layer.

Connectivity states may include RRC active state(s) and RRC non-active state(s), where, an active state is an operating state for transmission or reception of large traffic, e.g., that arrives continuously in a period; and a non-active state is an operating state for transmission or reception of less traffic, e.g., that arrives sporadically in a period. For example, the RRC active state can be RRC connected state, and the RRC non-active states can be RRC Inactive state and RRC Idle state. In some examples, the RRC active state(s) may include one RRC Connected state and other active state, for example, for some devices, UEs, applications, or services. The RRC non-active states may include one or more states other than RRC Inactive state and RRC Idle state.

Each connectivity state may be associated with one or more multiple operation power levels that are used to serve different applications and services such as NR eMBB, URLLC and mMTC, and other applications, where each operation power level may be configured with transceiver/RF info (e.g., transceiver type such as low cost or normal transceiver, antenna/MIMO, beam weights, transmission parameters), service type, and/or power consumption (e.g., max transmission power) for a connectivity state.

The connectivity states can, in some examples, be mutually transitioned or switched in a semi-static way via, e.g., RRC, MAC CE or/and in a dynamic way, via, e.g., DCI indication. The state transition can be based on traffic loading, service type, UE type and power consumption criteria, for example, low cost devices may stay in the RRC non-active state, and only occasionally transition to RRC active state for certain traffic that requires higher operation power levels, and transition back to an RRC non-active state after the higher power level operation.

In some examples, a rate of switching between power levels in a connectivity state is faster than a rate of switching between RRC active state and RRC non-active state. This is due to the fact that a change of wireless and mobile environment is more dramatic than traffic and application variation, where an operation power level is directly related to supporting the data transmission or reception with associated power consumption in the dynamic wireless and mobile environment, while a connectivity state is more associated with application type and its traffic variation.

There are multiple possible examples of ways to achieve the proposed goals or solutions, which are described briefly here and detailed in the following individual sections.

In one example, a power-level indication may include associated transceiver info, service type, and maximum transmission power, and the corresponding power level is associated with a connectivity state, e.g., RRC active state or RRC non-active state (in some places, we may omit “RRC” for simplicity and simply use terms “active state” or “non-active state”). A power level indicated by a power-level indicator (or indication) is an operation power consumption that can be controlled with fine granularity of power consumptions. In other words, a power consumption level is one of the power levels (or a set of power levels) that have been categorized or configured to support traffic or an application while making the power usage in a more efficient way. As a result, a power level is not only related to the maximum transmitted power but also associated with transmission and reception parameters that are involved in both digital and analog parts of the transceiver.

In some examples, such as those shown in FIGS. 7 and 8a, a power level may be associated with one or more of the following, an associated configuration profile: connectivity state, e.g., active state or non-active state, power-level index i, e.g., 1 or more bits for an indication, transceiver type, e.g., WUS (wake-up signal transceiver), MR (main transceiver), RF antenna configuration, e.g., MIMO parameters, QCLed (quasi co-located) beam and | RS (reference signal) configuration, Tx/Rx parameters, e.g., MCS (modulation and coding scheme), waveform, carrier and Max Transmission power.

Indicative of a Power Level with a Power-Level Index

A power level can be indicated by a power-level indicator that can be carried out in a message. Power levels in a connectivity state can be categorized or divided into a number of (N) levels, where indexing, from 0 to N−1, can be denoted by one or more bits for power-level indications. For example, J power levels are associated with an active state and can be indicated by, e.g., Pa_j, j=0, 1 . . . , J−1, and I power levels associated with non-active state and can be indicated by, e.g., Pna_i, i=0, 1, . . . , I−1. A power index with M-bits can indicate up to 2^{M} power levels for a connectivity state. Note that here Pa_j or Pna_i is used to indicate an operation power level that is associated with configuration of transceiver info, service type, and transmission parameters (including maximum transmission power), and other factors that are described below.

Indicative of a Power Level with a Connectivity State

A power level may be associated, indicated and configured with a connectivity state, where the connectivity state is active state (such as RRC Connected state) or non-active state (such as RRC Inactive or Idle state). An active state is an operating state for transmission or reception of large traffic, e.g., that arrives continuously in a period. There is more than one power level in an active state to support different types of traffic with power consumptions of different devices or users, as well as network in the active state. A non-active state is an operating state for transmission or reception of less traffic, e.g., that arrives sporadically in a period. There is more than one power level in an active state to support different types of traffic with power consumptions of different devices or users, as well as network in the non-active state.

Indicative of a Power Level with Transceiver Type and RF Configuration

A power level is associated, indicated and configured with transceiver type and RF configuration. A power level is associated with transceiver information configuration such as low-cost type or normal type transceiver, such as WUR (wake-up receiver) or MR (main receiver) at a device end, or/and LP-WUS (low-power wake-up signal transceiver) or normal transceiver at a base station end. In some cases, a low-cost transceiver may be used for non-active state and a normal transceiver may be used for active state. In other cases, an active state can use any or both of a low-cost transceiver and a normal transceiver, which is configurable. A configuration can be any or both of the following: semi-statically by, e.g., RRC, MAC-CE, and/or dynamically by, e.g., downlink control signaling (DCI). Moreover, the power level is associated with an antenna configuration, e.g., n Transmitter and m Receiver antennas, with n and m configured in a semi-static or dynamic way.

Indicative of a Power Level with QCLed Beam and RS Configuration

A power level may be associated, indicated and configured with QCLed (quasi-co-allocated) beam and RS (reference signal) configuration. Beam configuration may include indexed beams and beam direction, and its associated reference signals for beams, including antenna ports. The reference signals can be QCLed each other with a relationship between RSs from different beams and/or different transceiver types. In some cases, the reference signals form a normal transceiver may help the detection of the reference signals from a low-cost transceiver, where the QCL content, e.g., pass-loss or doppler coupling, can be defined or configured to support the applications cross beams, transceivers, bandwidth parts.

Indicative of a Power Level with Tx/Rx Parameters

A power level may be associated, indicated and configured with transmission and/or reception parameters. The transmission and reception parameters may be related to the power consumption level, and determine a variety of parameters such as modulation and coding scheme (MCS), signal waveform type (e.g., OFDM, single-carrier signal, non-OFDM, etc.), carrier frequency band and bandwidth part. It is noted that a different power (consumption) level may be configured a different set of transmission and reception parameters.

Indicative of a Power Level with Max Tx Power

A power level is associated, indicated and configured with maximum transmission power. The maximum power can be configured differently for a different power level (i.e., power consumption level). Sometimes, the maximum transmission power configuration may be related to device type or network node type; the maximum transmission power configuration may be related to application type or service type; or/and the maximum transmission power configuration may be related to mobility and environment.

### Power Level Switching Trigger in a Connectivity State

Here, mechanisms on triggering power-level changes are addressed. Power level switching can be applicable to any of or both of a UE and a network node, as shown in FIG. 8b. Power level switching can be triggered by one or more factors: HARQ feedback, channel measurement conditions, performance metrics such as block error rate (BLER), throughput, bandwidth switching, and carrier band switching, etc.

Power level switching can, for example, be based on HARQ feedbacks or as a function of ACK/NACK within certain period. In some cases, a consecutive number of ACKs in a configurable period may trigger operation power level switching to a lower power level, and a consecutive number of NACKs in a configurable period may trigger operation power level switching to a higher power level. In other cases, the power level switching may be based on a count of ACKs and a count of NACKs in a configurable period, for example, if the number of ACKs is large than the number of NACKs in the configurable period, power level switching can be trigged to change to a lower power level; otherwise, power level switching can be trigged to change to a higher power level. In this case, the power level switching is based on statistical channel quality, and thus it is relatively slower switching on a power level but could be more reliable.

Power level switching can, for example, be made from one power level to next immediate lower or higher power level, or from one power level to any other (i.e., not limiting to the immediately lower or higher power level) lower or higher power level. In some cases, a power level can be switched to a lower power level slowly down for one ACK while a power level may be switched quickly with more than one level to a higher power level upon receiving one NACK (at the reception end). This can be shown as FIG. 9 where the performance metrics or key performance indicator (KPI) can be pre-defined, pre-configured or configured by the network.

Power level switching can, for example, be based on channel measurement or environment conditions or as a function of different channels used or/and channel measurements, for example, the channels to be measured may include cell-common and UE specific channels for either control and data transmissions.

Power level switching can, for example, be based on other performance metrics such as block error rate, throughput, as well as other communication switching such as bandwidth switching and/or carrier band switching, etc. Moreover, beam switching or beam-width configuration change for a UE or a group of UEs may also be associated with power level switching.

Power level switching can, for example, be made via a power-level indication or indicator. Power level switching means current power level with an active operation will be deactivated while a new power level may be activated as an active operation to replace the current power level. Power level switching or signaling indication can be done in a dynamic way or semi-static way, including one or more of the following signaling example schemes.

UE specific based DCI: During a scheduling for a UE with a DCI, one or more new fields or modified fields in the DCI can be used to indicate a switching to a new power level from current power level. One or more bits can be used for the power level indication, where the number of bits can depend on how many power levels are defined/categorized or configured for a connectivity state.

Cell-common or group based DCI: During a system information broadcasting or a scheduling for a group of UEs with a DCI, new information in system information message (such as SSB) or group-common control signaling message (such as paging DCI or paging message) can be added and used to indicate a switching to a new power level from current power level. One or more bits can be used for the power level indication, where the number of bits can depend on how many power levels are defined or configured for a connectivity state.

RRC: Semi-static control signaling may be used to re-configure an active operation on a new power level while deactivating the operation of current power level.

MAC CE: Semi-static signaling embedded in data traffic (i.e., using MAC sub-header and control element) may be used to re-configure an active operation on a new power level while deactivating the operation of current power level.

Connectivity States and their Transitions

Connectivity states may include RRC active state(s) and RRC non-active state(s), where, for example, the RRC active state can be RRC connected state, and the RRC non-active states can be RRC Inactive state and RRC Idle state. In some examples, the RRC active state(s) may include one Connected state and other active state(s), for example, for some devices, UEs, applications, or services. The RRC non-active states may include one or more states other than RRC Inactive state and RRC Idle state.

Each connectivity state may be associated with one or more multiple power levels that are used to serve different applications and services such as NR eMBB, URLLC and mMTC, and other applications, where each power level is configured with transceiver/RF info (e.g., transceiver type such as low cost or normal transceiver, antenna/MIMO, beam weights, transmission and reception parameters), service type, and/or power consumption level (e.g., max Tx power) for a connectivity state. In some examples, switching of connectivity states may be based on transceiver types, traffic types, traffic loading, different QoS, etc. Moreover, a state transition period can be configured to implement the state transition between a state transition signaling being indicated and the state transition being actually performed.

The connectivity states can be mutually transitioned or switched, as shown in FIG. 8B, in a semi-static way via, e.g., RRC (e.g., RRC-reconfiguration message), MAC CE or/and in a dynamic way, via, e.g., DCI indication. The state transition can be triggered based on traffic loading, service type, UE type and power consumption criteria, for example, low cost devices may stay in the RRC non-active state, and only occasionally transition to RRC active state for certain traffic that requires a higher power level, and transition back to an RRC non-active state of the higher power level operation. In some examples, MAC CE with a header indicating to a state transition, and a transition duration (or gap) to provide a buffering time period to get the state transition ready. State transition is accompanied with new power level indication. The RRC-reconfiguration message may include power level indication or indicator, where the power level and indexing are among a configured set of power levels, and at least one power level is set up as default power level(s) with active operation (e.g., initially used power level). DCI can be optionally used to indicate with a power level indication to a power level with an active operation.

In other examples, for non-active state, more than one power level can be used to support different applications, services, QoS (quality of service), or device types, as shown in FIG. 10. The non-active state is a lower traffic state, but it may still need to monitor the network information and channel conditions, thus more than one power level can be used in terms of UE monitoring and paging detection on DL notification, for example, with low-cost or normal transceiver, etc. Moreover, a non-active state may operate with a power level with a low-cost transceiver, a normal transceiver or both, in which a power level can be configured to work with a different transceiver type and associated different transmission and reception parameters.

In some cases, a rate of switching between power levels in a connectivity state may be faster than a rate of switching between RRC active state and RRC non-active state. This can be due to the fact that a change of wireless and mobile environment may be faster than traffic and application variation. As a power level is more related to supporting the data transmission or reception in the wireless and mobile environment, while a connectivity state is more associated with application type and its traffic variation that could change more slowly, the rate of switching between power levels in a connectivity state can be faster than a state transition.

### Power Level Switching in an Intelligent Way

Power-level switching can be triggered in an intelligent way. For example, power-level switching can be determined by machine learning (ML) based inference.

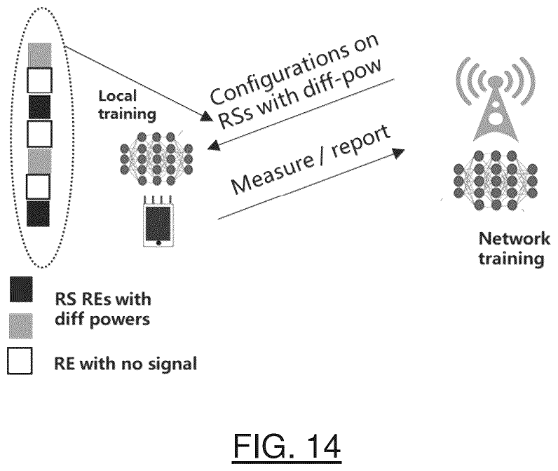

Here is an example of a machine learning based inference scheme based on device (or UE) local training or/and network global training. Shown in FIG. 14 is a scheme to learn operation power levels to impact wireless performance such as block error rate, throughput, signal to interference noise ratio, etc. Reference signals can be configured with different power or power density for resource elements in one or more reference signals such as SSB, CSI-RS, DMRS ( ), etc. After training in device/UE side, network side, or both sides, the performance as a function of power levels or power spectrum densities in resource elements can be learned in a machine learning algorithm. In this way, the inference from the machine learning algorithm can be obtained to help in better power-level switching in certain trained conditions. This is one way of power-level switching in an intelligent or adaptive way.

A few training scenarios to obtain inference or power-level switching mechanisms are given below:

BS (base station) side training and inference (DL): BS configures the RSs (over beams) with different power distributions, measurement metrics and reporting channels; UE provides channel measurements, and specifically on power-related performance impact metrics (e.g., interference, SINR BLER, etc.); UE reporting the metric measurements to BS; BS training with ML model based on UE measurement/training report, and provide inference control information, e.g., transmission power versus performance metric, where the training can be online, offline, periodically or intermittently.

UE side training and inference (DL): BS configures the RSs (over beams) with different power distributions, measurement metrics and reporting channels; UE performs channel measurements on the configured RSs, and specifically on power-related performance impact metrics (e.g., interference, SINR BLER, etc.), and feeds into a ML model for local training to generate the inference and control information, e.g., transmission power versus performance metric, where the training can be online, offline, periodically or intermittently; UE reporting the inference and control information to BS; Optionally, BS side performs training based on UE reporting, and BS may get inference for downlink power (consumption) level switching over the achievable performance metric.

UE sends the SRSs (Sounding Reference Signals) for network training (UL): BS configures the SRSs (over beams) with different power distributions, measurement metrics and reporting channels; UE sends sounding signals that are configured by BS; BS performs training with ML model and provides inference control information, e.g., transmission power versus performance metric, where the training can be online, offline, periodically or intermittently.

The present disclosure encompasses various examples, including not only method examples, but also other examples such as apparatus examples and examples related to non-transitory computer readable storage media. Examples may incorporate, individually or in combinations, the features disclosed herein.

Although this disclosure refers to illustrative examples, this is not intended to be construed in a limiting sense. Various modifications and combinations of the illustrative examples, as well as other examples of the disclosure, will be apparent to persons skilled in the art upon reference to the description.

Features disclosed herein in the context of any particular examples may also or instead be implemented in other examples. Method examples, for example, may also or instead be implemented in apparatus, system, and/or computer program products. In addition, although examples are described primarily in the context of methods and apparatus, other implementations are also contemplated, as instructions stored on one or more non-transitory computer-readable media, for example. Such media could store programming or instructions to perform any of various methods consistent with the present disclosure.

In this application, “at least one” means one or more, and “a plurality of” means two or more. “and/or” describes an association relationship of associated objects, and indicates that there may be three relationships. For example, A and/or B may indicate cases includes “only A”, “both A and B”, and “only B”, where A and B may be singular or plural. The character “/” generally indicates that the associated objects are in an OR relationship. “At least one of the following items” or a similar expression thereof refers to any combination of these items, including any combination of a single item or a plurality of items. For example, “at least one of a, b, or c” may represent a, b, c, “a and b”, “a and c”, “b and c”, or “a, b and c”, where a, b, and c may be a single or multiple form.

1. A method comprising:
receiving an indication of a first energy consumption level, wherein the first energy consumption level is one of a plurality of energy consumption levels, each energy consumption level in the plurality of energy consumption levels being associated with a corresponding configuration, the corresponding configuration including corresponding values for a plurality of parameters; and
performing a communication between a device and a network entity based on values for the plurality of parameters included in the configuration associated with the first energy consumption level.

2. The method of claim 1, wherein each energy consumption level in the plurality of energy consumption levels is associated with a corresponding operational state, wherein the corresponding operational state is one of a connected state, an inactive state, or an idle state.

3. The method of claim 1, further comprising:
before the receiving, receiving initial configuration information, the initial configuration information indicating the plurality of energy consumption levels and corresponding configurations.

4. The method of claim 1, wherein the plurality of parameters comprises at least one of: a transmission parameter; a reception parameter; an antenna parameter; a transceiver type; beam information or directional weights in an antenna for steering a beam direction; a modulation coding scheme parameter; a waveform parameter; a frame structure parameter; a numerology parameter; or a maximum transmission power parameter.

5. The method of claim 1, further comprising:
receiving an instruction to switch from the first energy consumption level to a second energy consumption level among the plurality of energy consumption levels, wherein the instruction is based on information regarding channel quality.

6. The method of claim 2, further comprising:
receiving an instruction to switch from a current operational state to a new operational state.

7. The method of claim 1, further comprising:
transmitting an indication of a proposed energy consumption level among the plurality of energy consumption levels; and
receiving an acknowledgement of a switch to the proposed energy consumption level.

8. A device comprising:
a memory storing computer-readable instructions; and
at least one processor, by executing the computer-readable instructions, causing the device to perform operations, the operations comprising:
receiving an indication of a first energy consumption level, wherein the first energy consumption level is one of a plurality of energy consumption levels, each energy consumption level in the plurality of energy consumption levels being associated with a corresponding configuration, the corresponding configuration including corresponding values for a plurality of parameters; and
performing a communication between the device and a network entity based on values for the plurality of parameters included in the configuration associated with the first energy consumption level.

9. The device of claim 8, wherein each energy consumption level, in the plurality of energy consumption levels, is associated with a corresponding operational state, wherein the corresponding operational state is one of a connected state, an inactive state, or an idle state.

10. The device of claim 8, wherein the operations further comprise:
before the receiving, receiving initial configuration information, the initial configuration information indicating the plurality of energy consumption levels and corresponding configurations.

11. The device of claim 8, wherein the plurality of parameters comprises at least one of: a transmission parameter; a reception parameter; an antenna parameter; a transceiver type; beam information or directional weights in an antenna for steering a beam direction; a modulation coding scheme parameter; a waveform parameter; a frame structure parameter; a numerology parameter; or a maximum transmission power parameter.

12. The device of claim 8, wherein the operations further comprise:
receiving an instruction to switch from the first energy consumption level to a second energy consumption level among the plurality of energy consumption levels, wherein the instruction is based on information regarding channel quality.

13. The device of claim 8, wherein the operations further comprise:
transmitting an indication of a proposed energy consumption level, among the plurality of energy consumption levels; and
receiving an acknowledgement of a switch to the proposed energy consumption level.

14. A method comprising:
transmitting an indication of a first energy consumption level, the first energy consumption level being one of a plurality of energy consumption levels, each energy consumption level in the plurality of energy consumption levels, being associated with a corresponding configuration, the corresponding configuration including corresponding values for a plurality of parameters; and
performing a communication between a network entity and a device based on values for the plurality of parameters included in the configuration associated with the first energy consumption level.

15. The method of claim 14, wherein each energy consumption level in the plurality of energy consumption levels is associated with a corresponding operational state, wherein the corresponding operational state is one of a connected state, an inactive state, or an idle state.

16. The method of claim 14, further comprising:
before the transmitting, transmitting initial configuration information, the initial configuration information indicating the plurality of energy consumption levels and corresponding configurations.

17. The method of claim 14, wherein the plurality of parameters comprises at least one of: a transmission parameter; a reception parameter; an antenna parameter; a transceiver type; beam information or directional weights in an antenna for steering a beam direction; a modulation coding scheme parameter; a waveform parameter; a frame structure parameter; a numerology parameter; or a maximum transmission power parameter.

18. The method of claim 14, further comprising:
transmitting an instruction to switch from the first energy consumption level to a second energy consumption level among the plurality of energy consumption levels, wherein the instruction is based on information regarding channel quality.

19. The method of claim 15, further comprising:
transmitting an instruction to switch from a current operational state to a new operational state.

20. The method of claim 14, further comprising:
receiving an indication of a proposed energy consumption level, among the plurality of energy consumption levels; and
transmitting an acknowledgement of a switch to the proposed energy consumption level.
